(19) United States
(12) Patent Application Publication
(10) Pub. No.: US 2012/0084323 A1
(43) Pub. Date: Apr. 5, 2012

(54) GEOGRAPHIC TEXT SEARCH USING IMAGE-MINED DATA

(75) Inventors: Boris Epshtein, Bothell, WA (US); Eyal Ofek, Redmond, WA (US)

(73) Assignee: MICROSOFT CORPORATION, Redmond, WA (US)

(21) Appl. No.: 12/896,879

(22) Filed: Oct. 2, 2010

(51) Int. Cl. G06F 17/30; H04N 7/18

(52) U.S. Cl. 707/776; 348/143; 707/E17.014; 707/E17.032; 707/E17.029; 348/E07.085

(57) ABSTRACT

Textual information may be harvested from photos that are associated with a geographic location, and the text may be used to respond to searches. In one example, photos are taken from a vehicle that has a camera and a GPS receiver. Each of the photos is marked with the geographic location at which it was taken, and text is extracted from the photos. Thus, each piece of text is associated with a particular geographic location, and the association between text and location is stored in a database. At some point in time, a query is received from a user, where the query specifies or implies a geographic criterion. The database is then examined to determine what items in the database meet the textual and geographic constraints of the query, and those pieces of information may be provided as search results.

### BACKGROUND

Many mapping applications provide a search feature that allows a user to search for a business based within some geographic location. Services such as BING maps and Google maps can process a query such as “Starbucks Redmond, Wash.,” in order to find locations of a Starbucks coffee store located in or near the city of Redmond, Wash. Processing such a query involves the use of a geographic database. Thus, there is some body of data that contains known Starbucks franchises, along with the presumed or apparent geographic location of these franchises.

Normally, geographic information about the location of businesses comes from business directories. For example, a directory might show that a Starbucks is located at “123 Main Street, Redmond, Wash.” Using map data, the approximate geographic location of this address can be determined. Thus, when a user asks for Starbucks locations in Redmond, Wash., the map application can identify a particular location based on information harvested from a directory. However, directory information may be incomplete or insufficient in at least two ways. First, many directories contain only street addresses and do not provide precise latitude and longitude information on the location of a business. The exact location of the business might not be deducible from the business's nominal street address. Second, there is information about a business that might be relevant in responding to a search but that might not be included in the directory.

### SUMMARY

Information about businesses and other locations may be harvested from images of the businesses—e.g., by using an Optical Character Recognition (OCR) process to extract the information from the image, by reading user-supplied annotations on the image, or by any other mechanism. The image may be associated with a geographic location. For example, images may be captured by devices that are connected to Global Positioning System (GPS) receivers, thereby allowing the location at which the image was captured to be known. Thus, the information harvested from the image may be stored in a database that associates the harvested information with a geographic location. The database may be used to respond to a geographically-limited search query. For example, a query may contain a text portion and a specification of a geographic location. A map application or search engine may use the database to find results that match the text portion of the query and that are associated with the geographic location of the query. In this way, a map application or search engine may use sources of information to respond to a query that are not available through an ordinary directory.

In one example, the text that is harvested from an image is a business name. However, other types of information may also be harvested from an image. For example, businesses may have signs that say “ATM inside,” “lottery,” “auto repairs,” “notary,” etc., which indicate the availability of services. These services might not be listed in an ordinary business directory in which the business itself is listed. Thus, the text harvested from the image may provide information to respond to a search that is not otherwise available through a business directory. Moreover, user-supplied photos may be tagged or annotated in some way that provides additional information. For example, a user might take a photo of a restaurant and might tag the photo with the word “fun.” The word “fun” can then be harvested from the tag, and that word can be associated with the geographic location at which the photo was taken. In this way, a map application or search engine may respond to a query such as “fun in Redmond, Wash.,” even though concepts such as “fun” generally are not listed in business directories.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process of creating a database of words and their geographic locations.

FIG. 2 is a flow diagram of an example process of responding to a query using a database of words and locations.

FIG. 3 is a block diagram of an example scenario in which a camera is mounted on a vehicle, and in which the vehicle travels through a street capturing photos.

FIG. 4 is a block diagram of an example scenario in which text is harvested from user-supplied information.

FIG. 5 is a block diagram of example components that may be used in connection with implementations of the subject matter described herein.

### DETAILED DESCRIPTION

Search engines often provide a local or geographic search. In some cases, the geographic search is integrated with the main search engine, while in other cases the geographic search is included as part of a mapping application that the search engine provides (e.g., BING maps, Google maps, etc.). Regardless of how a geographic search function is provided, the basic template of a geographically-limited search query is one or more search terms and a specification of geographic location. For example, the query “Starbucks Redmond, Wash.” would be generally understood by a search engine or mapping application to be a request for Starbucks franchises in the city of Redmond, Wash. Inasmuch as 98052 is the zip code from Redmond, Wash., the query “Starbucks 98052” would generally be understood in the same way. In both cases, the query contains a search term and a specification of the geographic location to which the search applies.

Responding to such a query involves maintaining database of information that is indexed geographically. A business directory might contain a listing of all Starbucks franchises in the world, but responding to the query “Starbucks Redmond, Wash.” involves having a database from which it can be determined which Starbucks are in Redmond, Wash. This geographic information is generally harvested from business directories—e.g., telephone directories and other databases that contain listings of businesses by address. Using street maps, it is possible to convert street addresses contained in such directories into approximate geographic locations. Using the geographic location of a business, it is possible to determine whether a business falls within some arbitrary geographic boundary (e.g., the city limits of Redmond, Wash.; a 1-mile-radius circle around the center of Redmond; some arbitrary polygon drawn on a map; etc.).

However, harvesting information from directories has some deficiencies. First, the location that is derived from a directory listing may be only approximate. Sometimes, the geographic location of a business is hard to deduce from its street address, due to problems such as streets with similar names, or densely-packed streets or shopping centers in which street addresses might not be assigned to buildings based in a regular pattern. Second, there is much information about a business that might not appear in a directory. If a business called “Quick Shop Convenience Store” is located at 123 Main Street in Redmond, then it is likely that listing for that business would appear in a directory. However, the business might provide banking, lottery sales, or other types of services that are not listed in the directory. The fact that these services are available might be determined from signage in front of the business, or from user-supplied information. Or, as another example, a single street address might be a shopping center that hosts several businesses—again, a fact that might be determinable from the signage in front of the building. But search engines generally do not attempt to harvest this type of information in order to respond to a search.

The subject matter herein may be used to harvest information from various sources in order to respond to a geographic search. Information about an entity (e.g., a business) at a specific location may be available from text that appears in a photo of the business, from user-supplied tags or annotations, or from other types of information. Thus, vehicle with a camera and GPS receiver mounted thereon may move through streets capturing street-side images. These images may contain signage on businesses. An OCR process may be used to extract text from the images, and the text may then be associated with the location from which the image was taken. This association between the text and the location may be stored in a database.

Additionally, images may be collected by various device users. For example, a person may carry a cell phone that has a camera and a GPS receiver. The person may use the phone to take a photo of a business, and may choose to propagate the photo as social media—e.g., as a post on a social network, a microblog entry, etc. This social media may contain annotation such as comments and/or tags, and may also contain the location from which the photo was taken (as determined by the GPS receiver). Any text contained in the image, as well as any text contained in the tags and/or comments, may be harvested. The text and the location from which the image was taken may be associated with each other, and this association may be stored in a database.

The database containing associations between text and images may then be used to answer geographic queries. For example, a query of the form “Starbucks 98052” may be answered using the database. However, queries might not be limited to business names, but rather might contain any type of text that could have been harvested from an image and/or from its annotations. Thus, a person who is looking for a lottery sales agent, an ATM machine, or simply a fun activity could enter a query such as “lottery 98052,” “ATM 98052,” or “fun 98052,” and such a query could be answered using the database.

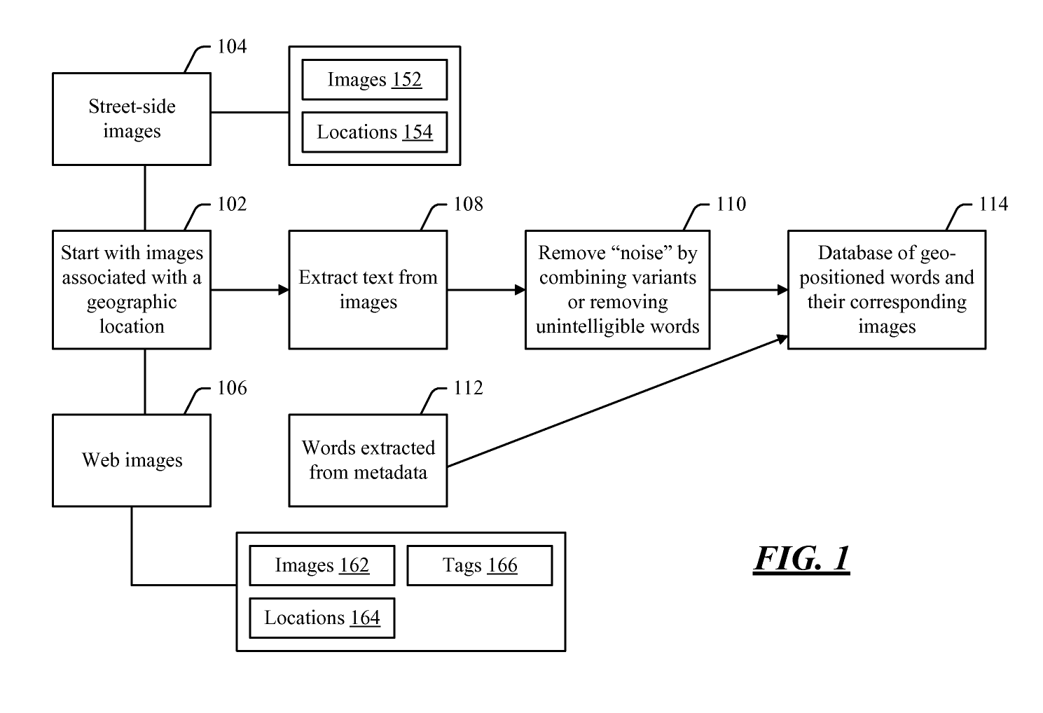

Turning now to the drawings, FIG. 1 shows an example process of creating a database of words and their geographic locations. At 102, the process starts with images that are associated with geographic locations. The images are “associated” with geographic locations in the sense that data exists stating the geographic location from which the image was taken and/or the geographic location of the item shown in the image. Such images have various sources, of which two example sources are shown in FIG. 1.

One example source is street side images 104, which may have been collected by a search engine provider, or mapping service provider, in order to provide street-level images. For example, the provider of such a service may have a car fitted with a camera and global positioning system (GPS) device. The car may drive through streets capturing images and recording the position at which each image was taken. Such images constitute street side images 104. In effect, this source comprises a plurality of image 152 associated with their respective locations 154.

Another example source of images associated with geographic locations is the set of tagged images that may be collected from the web (block 106). For example, people often upload photos to social networks, blogs, photo-sharing services, etc., and may annotate those photos with the geographic location at which the photo was taken. (In some cases, the photo may have been taken and uploaded with a mobile phone, and may have been tagged automatically with the location, using a GPS device on-board the phone). Such user-supplied photos, at block 106, constitute a source of images that are associated with geographic locations. In effect, this source comprises a plurality of images 162, with each image being associated with its corresponding location data 164 and/or user-supplied tag 166.

For any image associated with location data (such as the examples above), text may be extracted from the images to mine information from the image (at 108). For example, a particular image might show signs on buildings that contain the names of businesses (e.g., “Starbucks”), or that contain the words “gas”, “ATM” (Automatic Teller Machine), “lottery”, etc. Since the geographic location of each image is known, these words indicate what can be found at a particular location. One way to extract text from an image is to apply an Optical Character Recognition (OCR) process to the image to recover text that appears in the image. When text has been extracted, the extracted text may be processed to reduce “noise” (at 110).

The extraction process may recover partial words or misspellings (due to parts of words being occluded or unreadable), and thus may result in extraneous text being extracted. For example, a sign that says “Starbucks” might be extracted as “Starbacks” (if the letter “u” appears distorted in the image) or “Starbu” (if the trailing “cks” is occluded in the image). In order to avoid cluttering the database with incorrect words, the extraction process may impose, as a condition for storing a word in the database, that the word not be unintelligible. Thus, a noise reduction process (at 110) may attempt to ignore extractions of unintelligible words. (But any of the processes herein may be carried out without removing unintelligible words.) One way to ignore unintelligible words is to compare the extracted words to a dictionary of known words (which may include known business names), and to ignore any extracted word that does not match a word in the dictionary. Another example way to ignore unintelligible entries is to compare similar words that have been extracted from images of the same geographic location, and to treat some of the extracted words as being the same word—e.g., by choosing the variant of the word that appears more often than the others. For example, if—at a given location—the word “Starbucks” is extracted from five images of a storefront sign, and the word “Starbacks” is extracted from one image of that same sign, then the weight of evidence is that the word “Starbucks” is the actual word that appears on the sign, so “Starbacks” could be ignored and/or treated as a variant of “Starbacks.” One way to treat words as variants of each other is to store in a database only the form of the word that is likely to be correct. Another way would be to store both variants of the word, and to record the fact that the two words are variants of each other.

In addition to extracting words from the images themselves, words may be extracted from metadata (e.g., annotations) associated with the images (at 112). For example, a person might take a photo of a convenience store having a sign that says “lottery”. That person may also tag the photo with the word “lottery”, or might make a comment on the photo such as “lottery tickets sold here”. In this case, the photo itself contains the word “lottery,” which can be extracted by an OCR process. However, the user-supplied tag and/or comment also contains the word lottery, which—in addition to the word extracted from the photo—provides additional evidence that the location at which the image was taken contains a lottery sales agent.

When the text associated with the above images has been mined (by OCR and/or by examining metadata), the result is a database 114 of words and their corresponding geographic locations. E.g., if the word “ATM” appears in a photo, and the photo is known to have been taken at 47.592273 longitude, −122.322464 latitude, then it is known that the word “ATM” is associated with that location. This association between a word and a location can be stored in a database. Additionally, the original image (or other data) from which the word was obtained can be stored in the database.

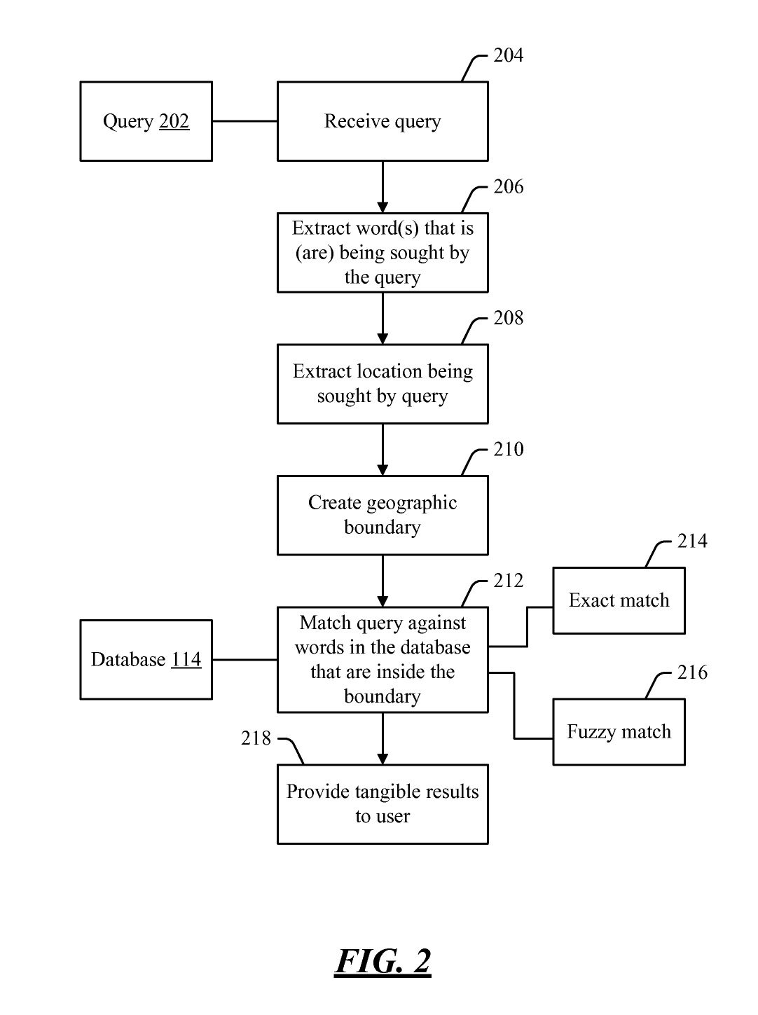

Once a database of words and their locations has been created, the database may be used to respond to a search query. FIG. 2 shows an example process of responding to a query using the database of words and locations.

Query 202 is a query that may include a text component and a location component. For example, “ATM 98052” is a query that requests an ATM in the zip code 98052 (which is Redmond, Wash.). This query is received (e.g., by a search engine) at 204. At 206, the one or more words being sought by the query are extracted from the query.

Additionally, at 208, the location that is being sought by the query is extracted. For example, in the case of the “ATM 98052” query, the word “ATM” is extracted from the query as being the word that describes the thing that the query is seeking, and the zip code 98052 is extracted as being descriptive of the location to which the query relates. It is noted that the act of assessing the terms and/or location to which a query relates may include inferring the query or a portion thereof. For example, if a query is received from a mobile device, then it might be inferred that the location to which the query relates is some radius around the device's current location, even if that location is not explicitly stated in the query. As another example, a user might submit a query that contains only a location, and it might be inferred that the user wants to see all businesses (or all of some other type of entity) within some radius of that location. (Or, the query might simply be blank, in which case it might be inferred that the user wants to see all businesses around the user's current location.) (Inasmuch as a query contains, or implies, or is understood to imply, some geographic region to which the query applies, the query may be described as a “geographically-limited” query.)

At 210, a geographic boundary is created that describes the location to which the query relates. For example, if the location to which the query relates is “98052”, then the boundary of the city of Redmond, Wash. (or a rectangle, or polygon, or circle, or ellipse, etc., that approximates that municipal boundary) may be created at 210. In some cases, the boundary may be limited by more than one factor. For example, “98052” might be interpreted as referring to the center of Redmond, Wash., rather than the whole city, in which case the boundary that is created at 210 might be a square that is one-quarter mile on each side, with the center of the square coinciding with the center of Redmond, Wash. In some cases, a user may have specified how large an area he or she is interested in. (E.g., the user may specify that he or she is interested in finding results that are 1 mile, or 5 miles, or 10 miles, from some specified point, in which case the boundary can be created accordingly).

At 212, the words in the query may be matched against words in the database that are associated with locations inside the boundary. For example, if the relevant query word is “ATM”, then that word may be matched against instances of the word “ATM” that are in database 114 and that are associated with geographic locations inside whatever boundary was created at 210. Thus, an instance of “ATM” that is associated with a location in downtown Redmond, Wash. would match the query “ATM 98052”, but an instance of “ATM” that is associated with a location in Chicago, Ill. would not match. The word match that is performed at 212 may be an exact match 214, or may be a fuzzy match 216. In an exact match 214, only a (possibly case-insensitive) character-for-character match would be treated as a match. In fuzzy match 216, a word in the database might be considered to satisfy the query even if the two words do not match character-for-character. E.g., the words might be considered matching as long as they are within some specified or pre-defined edit distance of each other. (Edit distance is the minimal number of insertions, deletions—and, in some formulations of the concept, substitutions—that have to be performed in order to transform one word into another.) The edit distance can be normalized for word length—e.g., the number of edits to convert one word to another could be divided by the length of one of the words, so that an edit distance of, say, one would be considered more significant for a three-letter word than for a six-letter word.

At 218, tangible results based on the match may be provided to the user (e.g., by displaying or otherwise communicating the results to the user). For example, a word in an image may be associated with a business or some other type of entity, and that entity may be returned to the user as part of the results. As one specific but non-limiting illustration, if an image contains a building with a sign that says “Starbucks”, then the text “Starbucks” may be harvested from the image, and the entity associated with this text is a particular Starbucks franchise located at a particular address. In this case, the Starbucks franchise that appears in the image is an example of an “entity”, and that entity may be returned as part of a set of search results. In one example, the search results may be ordered based on some criteria E.g., when the geographic component of a query is specified as a point (such as the center of a town), search results could be ordered based on how close they are to that point; or, in the case where some of the extracted text has errors, results could be presenting in descending order based on the number of errors (e.g., if “starbucks” and “starbacks” are both extracted from images, then the “starbucks” result could be presented before the “starbacks” result based on the assumption that “starbucks” is more likely to be non-erroneous).

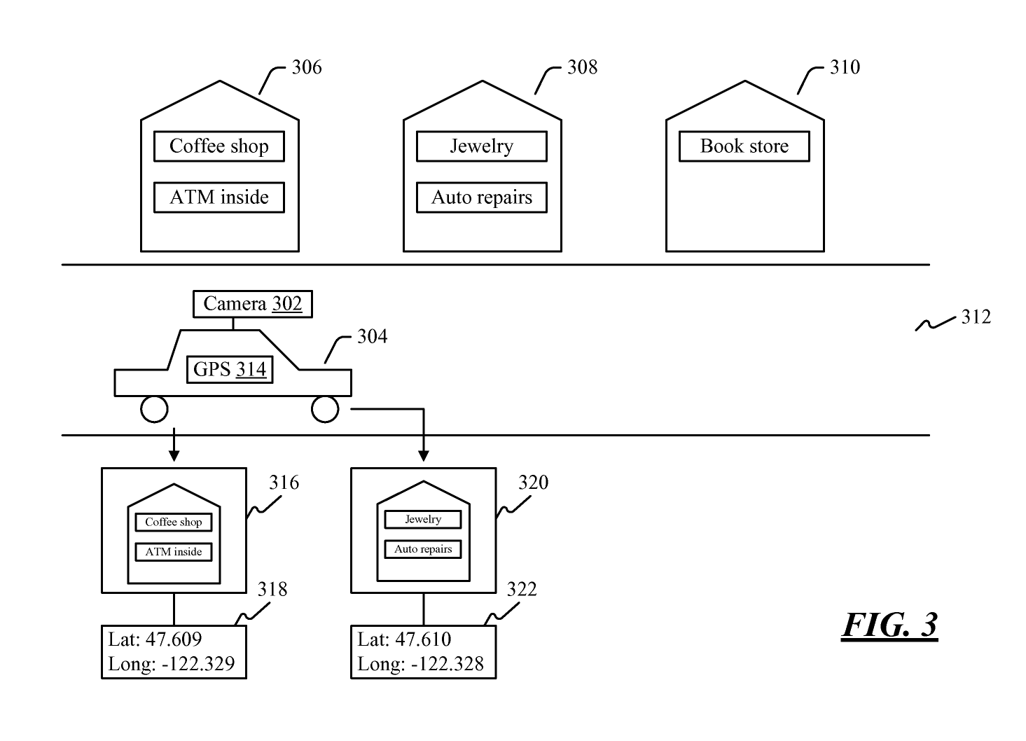

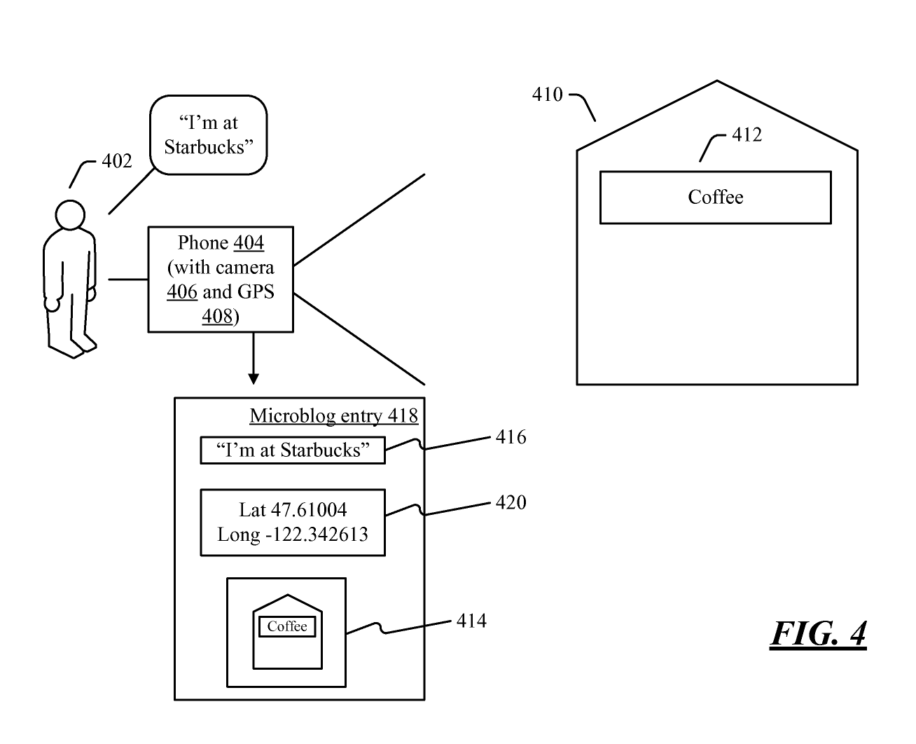

As explained above, the database of information that is used to perform a search may be harvested from photos that contain text associated with particular geographic locations. FIGS. 3 and 4 show two example scenarios in which such photos may be obtained.

FIG. 3 shows a scenario in which a camera 302 is mounted on a vehicle, 304, and the vehicle 304 travels through a street capturing photos. Buildings 306, 308, and 310 are located along street 312. As vehicle 304 travels on street 312, it takes photos of these buildings, which include signage on the buildings. For example, building 306 has signage that states “coffee shop” and “ATM”. These signs may indicate what types of businesses and/or services are available inside of building 306. Likewise building 308 has signs indicating “jewelry” and “auto repairs”, and building 310 has a sign indicating “book store.” These signs are captured as part of the photographs that are taken with camera 302.

The vehicle 304 on which camera 302 is mounted may have a global positioning system (GPS) receiver 314, which can identify the location of vehicle 304 at any given point in time. Thus, when a photo is taken by camera 302, GPS receiver 314 can be used to determine the location from which the photo was taken, and this location can be recorded along with the photo. Thus, as vehicle 304 drives along street 312 it captures photo 316 (which shows building 306), and stores a record that associates photo 316 with the location 318 from which photo 316 was taken (where that location may be specified in latitude and longitude coordinates). Similarly, when vehicle 304 is at a different position along street 312, it may capture photo 320 (which shows building 308), and may store a record that associates photo 320 with the location 322 from which photo 320 was taken. The text contained in the photos may be extracted (e.g., using an OCR process), and the extracted word (along with the geographic location of the photo from which the word was extracted) may be stored in a database (e.g., database 114 of FIG. 1).

FIG. 4 shows a scenario in which text is harvested from user-supplied information. In the example of FIG. 4, user 402 carries a mobile device such as phone 404. In this example, phone 404 is equipped with camera 406 and GPS receiver 408. User 402 may use camera 406 to take a photo. The user may propagate the photo as social media using some channel such as a social networking site, a microblog, etc. In the example of FIG. 4, user 402 takes a photo of building 410, which has signage 412 containing the word “coffee”. The user may combine this photo 414, as well as the text comment 416 “I′m at Starbucks” into microblog entry 418. Software on phone 404 may add the geographic location 420 at which the microblog entry was created (and/or the geographic location at which photo 414 was taken, if that geographic location happens to be different from the location at which the user creates the microblog entry). Microblog entry 418 may be propagated using an appropriate microblogging service, such as Twitter. Once microblog entry 418 has been propagated, it may be discovered by a web crawler, and the information contained in the entry may be harvested for indexing. For example, microblog entry 418 contains a geographic location 420, a photo 414 from which text can be extracted, and a text comment 416. The text contained in photo 414, and the text contained in comment 416, can be associated with geographic location 420, and the association between the text and the geographic location can be stored in a database (e.g., database 114, shown in FIG. 1). The information in the database then may be used to respond to searches, as described above in connection with FIG. 2.

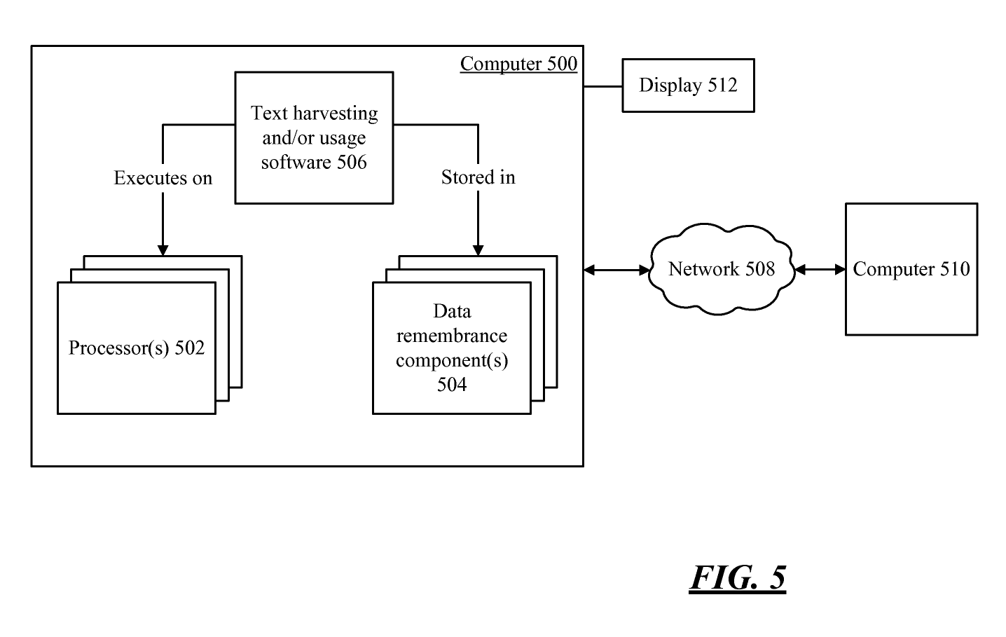

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is text harvesting and/or usage software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

It is noted that various items herein may be described as being “distinct” from each other in the sense that two items that are distinct are not the same item. For example, two non-identical words are distinct in the sense that they are not the same word. Or, two images that differ from each other in at least some manner are distinct in the sense that they are not the same image.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to perform a geographically-limited search, wherein the executable instructions, when executed by a computer, cause the computer to perform acts comprising:
extracting first text from user-supplied data that is associated with a first geographic location, said user-supplied data comprising a first image;
storing, in a database, said first text, said first geographic location, and an association between said first text and said first geographic location;
receiving a query that specifies second text and a second geographic location;
determining, based on said database, that said first geographic location is within said second geographic location and that said second text matches said first text;
based on said determining, creating results that comprise an entity associated with said first text; and
providing said results to a person.

2. The one or more computer-readable storage media of claim 1, wherein said user-supplied data further comprises a user-supplied annotation to said data, and where said first text is extracted from said user-supplied annotation.

3. The one or more computer-readable storage media of claim 1, wherein said acts further comprise:
performing an optical character recognition (OCR) process to extract said first text from said first image.

4. The one or more computer-readable storage media of claim 1, wherein said acts further comprise:
extracting third text from a second image, said second image being taken from a vehicle equipped with a camera and a global positioning system (GPS) receiver, wherein said vehicle uses said camera to capture street-side images while said vehicle is moving, and uses said GPS receiver to record locations at which each of said street-side images was captured, said second image being distinct from said first image.

5. The one or more computer-readable storage media of claim 1, wherein said first image is an image of signage on a business, and where said first text is not a name of said business.

6. The one or more computer-readable storage media of claim 1, wherein said acts further comprise:
inferring, based on a location from which said query is received, a boundary that defines said second geographic location.

7. The one or more computer-readable storage media of claim 1, wherein said acts further comprise:
inferring said query or a portion of said query.

8. The one or more computer-readable storage media of claim 1, wherein said acts further comprise:
determining, as a condition of including said first text in said database, that said first text is not unintelligible.

9. The one or more computer-readable storage media of claim 8, wherein said determining that said first text is not unintelligible comprises:
comparing said first text with a dictionary; and
determining that said first text is in said dictionary.

10. The one or more computer-readable storage media of claim 1, wherein said acts further comprise:
determining that said first text is a variant of a third text that is distinct from said first text; and
in said database, treating said first text and said third text as being the same text as each other.

11. A system for performing geographically-limited search, the system comprising:
a memory;
a processor;
a text harvesting component that is stored in said memory and that executes on said processor, wherein said text harvesting component receives an image and a first geographic location at which said image was captured, said image being of a business, wherein said text harvesting component extracts first text from said image, said first text not being a name of said business; and
a database in which said text harvesting component stores said first text, said first geographic location, and an association between said first text and said first geographic location.

12. The system of claim 11, further comprising:
a query processing component that receives a query that specifies second text, and that determines, based on said database, that said business satisfies said query due to said second text matching said first text and due to a second geographic location comprising said first geographic location, wherein said second geographic location is associated with said query.

13. The system of claim 12, wherein said query processing component infers, based on a third geographic location from which said query is received, a boundary that defines said second geographic location.

14. The system of claim 11, wherein said text harvesting component determines, as a condition for including said first text in said database, that said first text is not unintelligible.

15. The system of claim 14, wherein said text harvesting component determines that said first text is not unintelligible by comparing said first text with a dictionary and determining that said first text is in said dictionary.

16. The system of claim 11, further comprising:
determining that said first text is a variant of a third text that is distinct from said first text; and
in said database, treating said first text and said third text as being the same text as each other.

17. A method of obtaining information from an annotated image, the method comprising:
using a processor to perform acts comprising:
receiving data that comprises an image, a user-supplied annotation, and a first location at which said image was captured;
examining said annotation to recover first text from said annotation;
performing an optical character recognition (OCR) process to recover second text from said image;
storing, in a database, an association between said first text, said second text, said first location, and an entity that appears in said image;
receiving a query that comprises third text;
determining that said third text matches said second text or said first text, and that said query is associated with a second location that comprises said first location; and
based on said determining, communicating, to a person, a result that comprises said entity.

18. The method of claim 17, wherein said user-supplied annotation comprises a tag applied to said image.

19. The method of claim 17, wherein said user-supplied annotation comprises a comment.

20. The method of claim 17, wherein said acts further comprise:
determining that said first text and said second text are in a dictionary as a condition for including said first word and said second word in said database.
